(19) United States
(12) Patent Application Publication
(10) Pub. No.: US 2008/0244511 A1
(43) Pub. Date: Oct. 2, 2008

(54) Developing a writing system analyzer using syntax-directed translation

(75) Inventors: Worachai Chaoweeraprasit, Redmond, WA (US); Zhanjia Yang, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/731,527

(22) Filed: Mar. 30, 2007

(51) Int. Cl. G06F 9/44

(52) U.S. Cl. 717/109

(57) ABSTRACT

A method for developing a writing system analyzer. In one implementation, a writing system may be represented in syntax-directed translation. The syntax-directed translation representation of the writing system may be compiled to generate a writing system analyzer. In one implementation, the writing system may be represented in syntax-directed translation by creating an environment using header files with one or more declarations in source code form and formulating one or more rules for representing the writing system using the declarations.

### BACKGROUND

As computing systems become available throughout the world, the ability to display complex writing systems becomes increasingly important. In general, the process of displaying text includes analyzing an input string of character codes according to a particular writing system, transforming the input string of character codes into a sequence of glyph indices and displaying the final sequence of glyph indices on a graphical device. Character codes are numerical designators for characters defined by Unicode, an industry standard list of approximately one million characters and their associated numerical designators designed to allow symbols from various writing systems in the world to be consistently represented and manipulated by computers.

A writing system may be defined as a symbolic system used to represent statements expressible in human language. A glyph index may be defined as the zero-based integral value used to refer to a particular glyph, or shape given in a particular typeface to a symbol of a writing system. For example, glyph indices may represent letters of the alphabet, punctuation, symbols, and the like. Further, glyph indices may represent elements used to form complex combinations of glyph indices representing characters in writing systems such as Hindi or Chinese. The process of displaying text may be understood as the computing system receiving the Unicode character codes from the input keystrokes, mapping those character codes to appropriate glyph indices for a particular writing system and displaying the glyphs. For some writing systems, such as English, the mapping process is a simple one to one mapping. However, in other writing systems, such as Hindi, the mapping process may be very complex with ten character codes mapping to five glyph indices in a different order than inputted.

Typically, the input string of character codes may be analyzed by complex custom code and transformed into a sequence of glyph indices. Each writing system supported by a computing system requires extensive custom code to handle the intricacies of that writing system. Therefore, the effort required to encode, test and maintain each writing system is monumental, requiring huge amounts of time and money. Moreover, the custom code is not extendable such that new writing systems cannot be easily added. A need exists for a new way in which a writing system may be developed and maintained.

### SUMMARY

Described herein are implementations of various technologies for developing a writing system analyzer. In one implementation, a writing system may be represented in syntax-directed translation and then compiled to generate a writing system analyzer. In order to represent the writing system in syntax-directed translation, an environment for developing a writing system in syntax-directed translation may be established. The environment may include header files having one or more declarations in source code form. The header files may define template types and overridden operators. The header files may further define a class for establishing a uniform manner in which the writing system is represented in syntax-directed translation. After the environment is established, variables necessary for describing the writing system may be defined. One or more rules may then be formulated using the declarations to represent the writing system in syntax-directed translation.

In another implementation, the writing system may be represented in syntax-directed translation using a pre-defined set of header files.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various technologies described herein may be incorporated and practiced.

FIG. 2 illustrates an environment for developing a syntax-directed translation representation of a writing system in accordance with implementations of various technologies described herein.

FIG. 3 illustrates a flow diagram of a method for developing a writing system analyzer based on a syntax-directed translation representation of a writing system in accordance with implementations of various technologies described herein.

### DETAILED DESCRIPTION

In general, one or more implementations of various technologies described herein may be directed to an environment for developing a syntax-directed translation representation of a writing system, which may be referred to as a writing system definition. Syntax-directed translation may be defined as a method of analyzing a text string and generating an ordered list of instructions used to map the text string into a sequence of glyph indices. Syntax-directed translation may be applied by formulating context-free grammar rules and attaching one or more instructions to each rule. Thus, analyzing a text string using the context-free grammar rules produces an ordered list of instructions to map the text string into a sequence of glyph indices. A context-free grammar may be defined as the mathematical representation of rules that govern structural patterns. As such, syntax-directed translation may be used as a method for defining how to analyze a set of strings representing a formal language, i.e., a language defined by mathematical formulas, and generate an ordered list of instructions to map the set of strings into a sequence of glyph indices. Thus, a writing system definition may be defined as the mathematical representation of a set of rules of writing symbols that form a written human language. The writing system definition may include the context-free grammar rules and the associated instructions.

In accordance with various implementations described herein, the environment for developing a writing system definition may be established by creating an expressive language inside a programming language. Within a programming language, features such as generic types, overridden operators, classes and the like may be used to create an expressive language designed to develop a writing system definition.

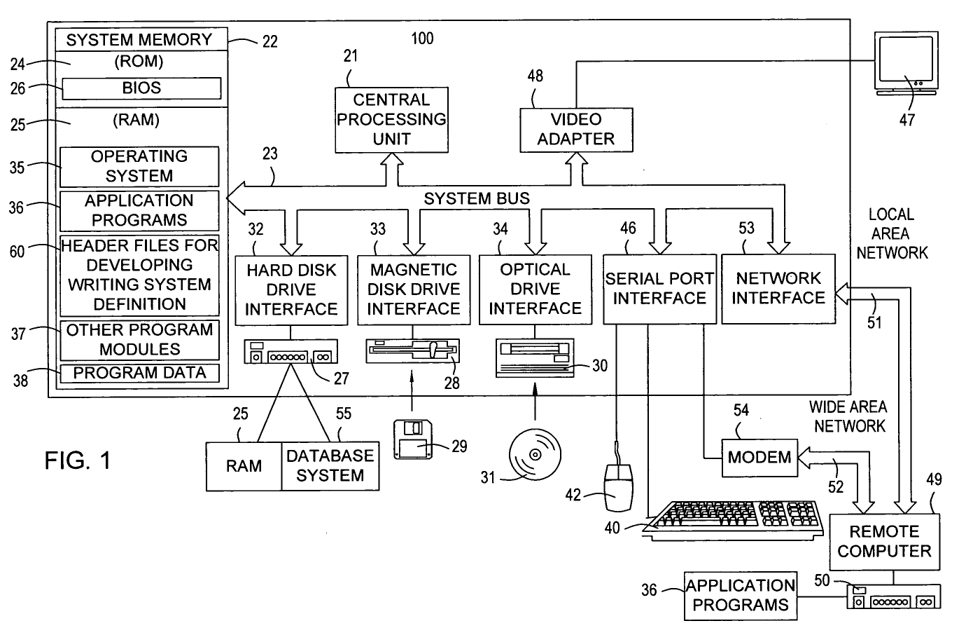

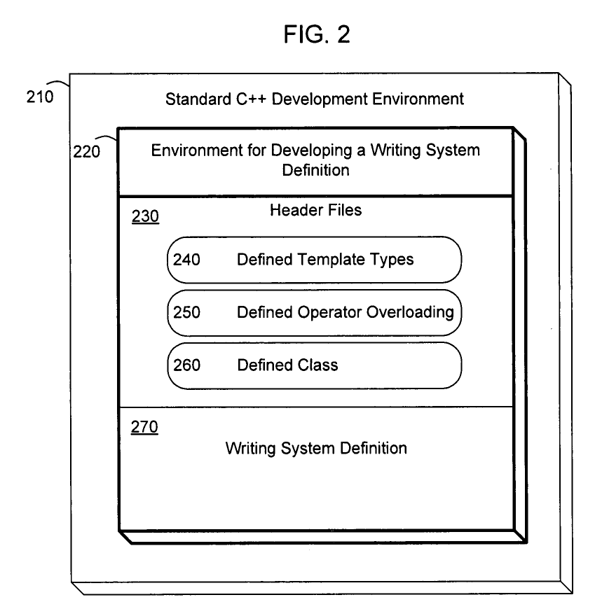

In one implementation, the environment for developing a writing system definition may be established using an expression template technique for creating an expressive language inside the standard C++ development environment. The expression template technique applies the C++ template type and operator overloading features to create an expressive language tailored to a particular programming goal, i.e., developing a writing system definition. Various techniques for creating an environment for developing a writing system definition in accordance with various implementations are described in more detail with reference to FIGS. 1-2 in the following paragraphs.

One or more implementations of various technologies described herein may also be directed to a method for developing a writing system analyzer based on a writing system definition. A writing system analyzer is an executable program designed to parse or analyze a sequence of tokens to determine its grammatical structure with respect to the writing system and to produce an ordered list of instructions to map the input tokens into a sequence of glyph indices. A sequence of tokens may be an input string of Unicode character codes. Because syntax-directed translation source code may be compiled to auto-generate an analyzer, constructing a writing system definition leverages compiler techniques to allow a writing system analyzer to be auto-generated, thereby eliminating the need for complex written programming language code. A writing system analyzer generated from a writing system definition may also simplify parsing because syntax-directed translation may define the structural pattern of tokens, making it possible to define a syntax tree for the writing system. Various techniques for a method for developing a writing system analyzer in accordance with various implementations are described in more detail with reference to FIGS. 1-3 in the following paragraphs.

Although various programming languages may be used for establishing an environment for developing a writing system definition and developing a writing system analyzer, the following figures and discussion describe implementations with reference to the C++ programming language.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk, magnetic disk 29, optical disk 31, ROM 24 or RAM 25, including an operating system 35, one or more application programs 36, header files for developing a writing system definition 60, other program modules 37, program data 38 and a database system 55. The operating system 35 may be any suitable operating system that may control the operation of a networked personal or server computer, such as Windows® XP, Mac OS® X, Unix-variants (e.g., Linux® and BSD®), and the like.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more remote computers, such as a remote computer 49. The remote computer 49 may be another personal computer, a server, a router, a network PC, a peer device or other common network node. Although the remote computer 49 is illustrated as having only a memory storage device 50, the remote computer 49 may include many or all of the elements described above relative to the computing system 100. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

In one or more implementations of various technologies described herein, an environment for developing a writing system definition may be established. As mentioned above, a writing system definition may be defined as the representation of a writing system using syntax-directed translation. In one implementation, the expression template technique for creating an expressive language inside the standard C++ development environment may be used to establish an environment for developing a writing system definition. Accordingly, the C++ template type and operator overloading features may be applied. A set of defined template types, referred to as a C++ template library, may be created. A C++ template library is a set of related template types which serve the purpose of constructing a particular kind of programming task, in this case for developing a writing system definition. In addition, the operator overloading may be defined. Further, a class may be defined as a base class for all writing system development. The defined template types, defined operator overloading, and defined class may be considered header files. Header files are a set of files that contain one or more declarations in source code form. The header files may be included in source code formulating a writing system definition such that the defined template types, defined operator overloading and defined class may be used by a developer to formulate a writing system definition.

FIG. 2 illustrates an environment 220 for developing a syntax-directed translation representation of a writing system, i.e., writing system definition, in accordance with implementations of various technologies described herein. In one implementation, the environment 200 may be built in a standard C++ development environment 210. As such, the environment 220 for developing a writing system in syntax-directed translation may be established by header files 230, which may include defined template types 240, defined operator overloading 250 and a defined class 260. The header files 230 may be used to create an expressive language specifically for developing a writing system definition 270. The header files 230 may be built in a standard C++ development environment 210 using the C++ template type and operator overloading features.

The defined template types 240 may be a set of related template types used to construct a writing system definition. The set of template types may be a C++ template library. Template types allow code to be written without consideration of the real data type with which it may be used. A template type may indicate to the compiler the final form of the auto-generated code. When a template type is used in source code, the compiler recognizes the template type and processes it in accordance with the established template type definition. For example, the template type Symbol may be defined to represent an expression that matches a single character. Accordingly, the expression “pz::Symbol<‘a’>” in source code may represent an expression that matches a single character ‘a’. The defined template types 240 may include template types, such as Symbol, SymbolRange, SymbolKind and the like.

The C++ operator overloading feature may be configured to allow a single definition of a programming language operator to have different implementations depending on the type of the argument. For example, the programming language operator “>” may be overloaded such that if the argument type is text rather than numbers, the operator “>” may be implemented as a sequence operator rather than as a “greater than” operator. As such, the defined operator overloading 250 may be configured to define the “>” operator as a sequence operator, the operator “|” as a branch operator, the operator “*” as a repeater operator, the operator “−” as a subtractor or except, the operator “˜” as a unary operator and the like.

The defined class 260 may be class “pz::Script” defined by source code to implement a base class for all writing system development. A base class may be established to define a uniform way in which the execution of the writing system definition is started. In addition, the base class may define commands to be used in an ordered list of instructions to direct the formation of the final sequence of glyph indices. For example, a command, “Change”, may be defined to mean “apply the specified glyph index substitution feature on the range of text at the top of the stack.” Commands such as “Change” may be used in the writing system definition development to describe the actions necessary to form the final sequence of glyph indices. The defined base class 260 may define commands such as “Push”, “Pop”, “Pushadd”, “Change”, “Move”, “Reverse”, “Basify” and the like.

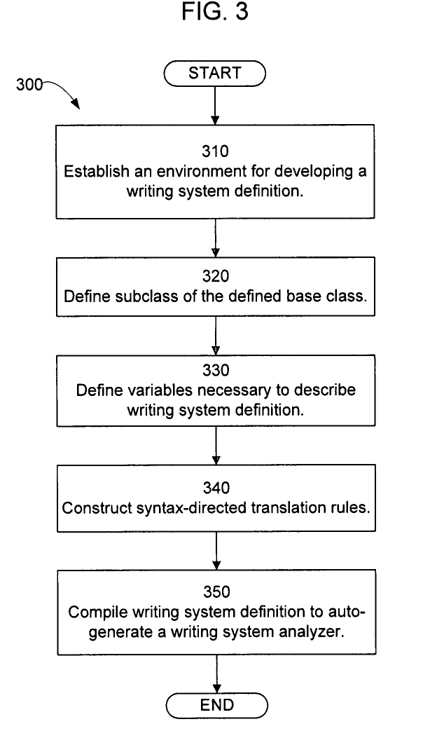

The environment 220 for developing a writing system definition may be used by a developer to formulate a writing system definition. The writing system definition may be compiled to generate a writing system analyzer. A writing system analyzer may include executable code designed to analyze a set of input strings of Unicode character codes to determine their grammatical structure with respect to the writing system. FIG. 3 illustrates a flow diagram of a method 300 for developing a writing system analyzer based on a syntax-directed translation representation of a writing system, i.e. writing system definition, in accordance with implementations of various technologies described herein. It should be understood that while the operational flow diagram of the method 300 indicates a particular order of execution of the operations, in some implementations, the operations might be executed in a different order.

At step 310, an environment for developing a writing system definition may be established. In one implementation, the environment for developing a writing system definition described above in FIG. 2 may be used.

At step 320, a writing system definition may begin to be formulated by first defining a subclass of the defined base class. In one implementation, a subclass to the class pz::Script may be defined. For example, if the Devanagari writing system definition is being formulated, a subclass titled “Devanagari” may be defined.

At step 330, variables necessary to describe the writing system definition may be defined. A variety of variable-types may be defined such as symbols, ranges, syntax-directed translation rule titles and the like. Each writing system definition constructed may have different variable types defined as well as different specific variables defined. It should be understood that only variables necessary to construct the writing system definition may be defined. For example, a symbol variable called “VIRAMA” may be defined for the Devanagari writing system definition. “VIRAMA” is a special symbol that follows a consonant and suppresses the consonant's inherent vowel sound. A symbol variable representing “VIRAMA” may be needed to construct the syntax-directed translation rules for Devanagari. Therefore, when constructing the writing system definition for Devanagari, “VIRAMA” may be defined in this step.

A symbol variable may define a specific Unicode character code. For example, continuing with the Devanagari example, the source code

const pz::Symbol<0x94D> VIRAMA
uses the Symbol template type to define the Unicode character code value 0x94D as a variable VIRAMA.

A symbol range variable may be defined as ranges of Unicode character codes. Any character code within the specified range of Unicode values may be captured by the symbol range variable. For example, the source code

const pz::SymbolRange<0x915, 0x939> CONS_{—}
const pz::SymbolRange<0x904, 0x914> INDEPENDENT_VOWEL_{—}
uses the SymbolRange template type to define the Unicode character code value 0x915 to 0x939 as a variable CONS_ and the Unicode character code value 0x904 to 0x914 as a variable INDEPENDENT_VOWEL_.

A syntax-directed translation rule title variable may be defined. For example, continuing with the Devanagari example, the source code

### pz::Rule LeadCons_{—}

defines a variable LeadCons_ to hold the result of a syntax-directed translation rule such as the ones defined in step 340 below.

At step 340, the syntax-directed translation rules may be constructed. Syntax-directed translation rules may be defined as the context-free grammar representation of the rules of writing a particular human language and the attached instructions used to map a text string into the glyph indices of the human language. The writing system may be described using syntax-directed translation to “teach” the computer the writing system. The template types, operator overloading and commands defined in step 310 may be used with the variables defined in step 330 to construct the rules of a writing system. For example, the writing system may have a rule that the lead consonant may be either a consonant or an independent vowel. The following syntax-directed translation rule may be constructed to represent the writing system rule:

### LeadCons_=CONS_| INDEPENDENT_VOWEL_.

The above syntax-directed translation rule example may appear to be simple. However, syntax-directed translation rules may be very complex and include a number of attached instructions to direct the formation of the final sequence of glyph indices. For example, commands such as “Push”, “Pop”, “Pushadd”, “Change”, “Move”, “Reverse”, “Basify” and the like, as described in the above paragraphs may be included in the syntax-directed translation rules. The writing system definition may include many syntax-directed translation rules.

At step 350, the writing system definition may be compiled by a compiler to auto-generate the executable binary code for a writing system analyzer. The writing system analyzer may include executable code designed to analyze an input string of Unicode character codes to determine its grammatical structure with respect to the writing system and to generate an ordered list of instructions to map the input text string into a sequence of glyph indices. The writing system analyzer may be a recursive-descendent analyzer program of the writing system defined by the syntax-directed translation. The writing system analyzer may be automatically generated when syntax-directed translation is compiled by the compiler.

In this manner, a writing system analyzer may be generated for any writing system that may be represented in syntax-directed translation. The method may be repeated for any number of writing systems to generate writing system analyzers specific to each writing system. A writing system analyzer may be used in a variety of implementations such as to interpret a text string and display the written form of the text string, to recognize correct sequencing of a text string, and the like.

Although various implementations may be described herein with reference to the C++ programming language, it should be understood that in other implementations other programming languages may be used. As such, various tasks represented by concepts such as template types, operator overloading and classes may be implemented in other programming languages by similar mechanisms bearing other names.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for developing a writing system analyzer, comprising:
representing a writing system in syntax-directed translation; and
compiling the syntax-directed translation representation of the writing system to generate a writing system analyzer.

2. The method of claim 1, wherein the writing system analyzer is configured to analyze a text string and generate an ordered list of instructions to map the text string into a sequence of glyph indices.

3. The method of claim 1, wherein representing the writing system in syntax-directed translation comprises:
creating an environment for representing the writing system in syntax-directed translation, wherein the environment comprises one or more header files having one or more declarations in source code form; and
formulating one or more rules for representing the writing system in syntax-directed translation using the declarations.

4. The method of claim 3, wherein the header files define a class configured to establish a uniform manner in which the writing system is represented in syntax-directed translation.

5. The method of claim 4, wherein representing the writing system in syntax-directed translation further comprises defining one or more subclasses for one or more writing systems.

6. The method of claim 3, wherein the header files define one or more template types, one or more overridden operators and one or more commands to direct the formation of a final sequence of glyph indices.

7. The method of claim 6, wherein representing the writing system in syntax-directed translation further comprises formulating the rules for representing the writing system in syntax-directed translation using the template types, the overridden operators, and the commands to direct the formation of the final sequence of glyph indices.

8. The method of claim 3, wherein representing the writing system in syntax-directed translation further comprises defining one or more variables for the writing system to be represented in syntax-directed translation.

9. The method of claim 1, wherein representing the writing system in syntax-directed translation comprises:
using one or more predefined header files having one or more declarations in source code form; and
formulating one or more rules for representing the writing system in syntax-directed translation using the declarations.

10. A method for representing a writing system in syntax-directed translation, comprising:
creating one or more header files having one or more declarations in source code form;
defining one or more variables for the writing system; and
formulating one or more rules for representing the writing system in syntax-directed translation using the declarations and the variables.

11. The method of claim 10, wherein the header files define one or more template types, one or more overridden operators, and one or more commands to direct the formation of a final sequence of glyph indices.

12. The method of claim 11, wherein the rules for representing the writing system in syntax-directed translation are formulated using the template types, the overridden operators and the commands to direct the formation of the final sequence of glyph indices.

13. The method of claim 11, wherein the template types comprise a C++ template library.

14. The method of claim 10, wherein the header files define a class configured to establish a uniform manner in which the writing system is represented in syntax-directed translation.

15. The method of claim 14, further comprising defining one or more subclasses for one or more writing systems.

16. A memory for storing data for access by an application program being executed on a processor, the memory comprising: a data structure for one or more header files stored in the memory, the data structure comprising one or more template types and one or more overridden operators used for representing a writing system in syntax-directed translation.

17. The memory of claim 16, wherein the data structure further comprises a class to establish a uniform manner in which the writing system is represented in syntax-directed translation.

18. The memory of claim 17, wherein the class comprises a set of predefined commands.

19. The memory of claim 18, wherein the set of predefined commands are used to direct formation of glyph indices based on the writing system.

20. The memory of claim 16, wherein the template types comprise a C++ template library.
